(19) United States
(12) Patent Application Publication
(10) Pub. No.: US 2004/0265665 A1
(43) Pub. Date: Dec. 30, 2004

(54) PEMFC electrocatalyst based on mixed carbon supports

(76) Inventors: Susan G. Yan, Fairport, NY (US); Brian A. Litteer, Henrietta, NY (US)

Correspondence Address: CARY W. BROOKS, General Motors Corporation, Mail Code 482-C23-B21, P.O. Box 300, Detroit, MI, 48265-3000, US

(21) Appl. No.: 10/851,695

(22) Filed: May 21, 2004

Related U.S. Application Data
(63) Continuation-in-part of application No. 10/765,816, filed on Jan. 27, 2004.
Application No. 10/765,816 is a continuation-in-part of application No. 10/360,999, filed on Feb. 7, 2003, now abandoned.

(51) Int. Cl. H01M 4/96; H01M 8/10; H01M 4/92; B01J 21/18

(52) U.S. Cl. 429/30; 429/44; 502/185

(57) ABSTRACT

A membrane electrode assembly for a proton exchange membrane fuel cell that employs an improved catalyst. The catalyst is a mixture of a first catalyst and a second catalyst. The first catalyst is a 50 wt % Pt formed on Vulcan XC72 carbon having a BET surface area of about 250 m²/g. The second catalyst is a 50 wt % Pt formed on Ketjen Black carbon having a BET surface area of about 800 m²/g. The ratio of the first catalyst to the second catalyst is 1:1.

This application is a Continuation-In-Part of U.S. Appln No. 10/765,816 filed on Jan. 27, 2004, which is a Continuation-In-Part of U.S. Appln No. 10/360,999 filed on Feb. 7, 2003.

### BACKGROUND OF THE INVENTION

1. Field of the invention

This invention relates generally to a hydrogen fuel cell system and, more particularly, to a membrane electrode assembly (MEA) for a polymer electrolyte membrane fuel cell (PEMFC) employing an improved electrode catalyst.

2. Discussion of the Related Art

Hydrogen is a very attractive source of fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas and the cathode receives oxygen or air. The hydrogen gas is dissociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode. The work acts to operate the vehicle. Many fuels cells are combined in a stack to generate the desired power.

PEMFCs are a popular fuel cell for vehicles. In a PEMFC, hydrogen (H₂) is the anode reactant, i.e., fuel, and oxygen is the cathode reactant, i.e., oxidant. The cathode reactant can be either pure oxygen or air (a mixture of O₂ and N₂). The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The combination of the anode, cathode and membrane define a membrane electrode assembly (MEA). MEAs are relatively expensive to manufacturer and require certain conditions for effective operation. These conditions include proper water management and humidification, and control of catalyst poisoning constituents, such as carbon monoxide (CO).

FIG. 1 is a cross-sectional view of a simplified MEA 10 for a PEMFC. The MEA 10 includes a cathode 12, an anode 14 and a thin polymer electrolyte proton conducting membrane 16 sandwiched therebetween. The cathode 12 includes a gas diffusion layer 18 and a cathode catalyst layer 20 fabricated on a surface of the diffusion layer 18 proximate the membrane 16, as shown. The catalyst layer 20 includes dispersed carbon particles 22 having platinum particles 24 adhered thereto. Likewise, the anode 14 includes a gas diffusion layer 26 and an anode catalyst layer 28 formed on a surface of the diffusion layer 26 proximate the membrane 16, as shown. The catalyst layer 28 includes dispersed carbon particles 30 having platinum particles 32 adhered thereto.

The platinum catalyst dissociates the hydrogen protons and electrons from the hydrogen fuel in the anode 14 and combines the electrons, hydrogen protons and oxygen in the cathode 12 to generate water. The cathode catalyst layer 20 and the anode catalyst layer 28 can be identical to provide this chemical operation. The performance of the PEMFC is limited by the oxygen reduction reaction (ORR) in the cathode 12 because the oxygen atoms are larger and slower than the hydrogen atoms in the anode 14. Thus, the reaction of oxygen with the platinum in the cathode 12 is slower than the reaction of hydrogen with the platinum in the anode 14. Therefore, it is important to provide a catalyst region that provides for a good access of the oxygen atoms to the platinum particles 24 within the catalyst layer 20.

Different size particles of carbon in a powder format can be provided to allow the platinum particles to attach thereto. It is desirable to make the size of the carbon particles small enough so that there is more surface area for receiving the platinum. However, as the size of the carbon particles decreases, the porosity of the catalyst layer decreases, which reduces the ability of the catalyst layer to allow gas transport, including the hydrogen and oxygen gas, and the ability of the catalyst layer to vent water.

Various catalysts are known in the art for the catalysts layers 20 and 28. Currently, the best MEA catalysts include 40-50 weight percent (wt %) of platinum (Pt) adhered to a carbon support. Two well known catalysts for an MEA include a 50 wt % Pt formed on Vulcan XC72 carbon having a BET surface area of about 250 m²/g (hereinafter catalyst 1), and a 50 wt % Pt formed on Ketjen Black carbon having a BET surface area of about 800 m²/g (hereinafter catalyst 2). BET is a measure of how much nitrogen is adsorbed onto the surface of the carbon particles, which can be related to the surface area, i.e., the size of the carbon particles in the powder. Thus, the BET surface area defines the porosity of the carbon. A higher value BET surface area has smaller particles of carbon to allow more platinum to be attached thereto. A lower value BET surface area has larger particles of carbon that provide less surface area, but more porosity for the flow of the water and gases through the diffusion layers 18 and 26, the membrane 16 and the catalyst layers 20 and 28. Therefore, the catalyst 1 has more porosity, but less carbon surface area to which the platinum can adhere to than the catalyst 2.

FIG. 2 is a graph with voltage on the vertical axis and current density on the horizontal axis showing polarization curves for both oxygen and air for the catalysts 1 and 2. The catalysts 1 and 2 have a platinum density (loading) of 0.4 mg Pt/cm², 150 kPa, T_{cell}=80 C, dewpts=80/80C, and stoichiometry=2.0 H₂ anode and on the cathode, either 9.5 for pure oxygen or 2.0 for air. The thickness of the catalyst 1 layer is approximately 13-14 μm and the thickness of the catalyst 2 layer is approximately 10 μm. The electrochemical platinum surface area is lower (55 m²/g) for the catalyst 1 as compared to 66 m²/g for the platinum supported on the catalyst 2.

Graph line 40 is the voltage for the catalyst 1 when oxygen is the cathode oxidant, graph line 42 is the voltage for the catalyst 2 when oxygen is the cathode oxidant, graph line 44 is the voltage for the catalyst 1 when air is the cathode oxidant, and graph line 46 is the voltage for the catalyst 2 when air is the cathode oxidant. The voltage on the vertical axis does not include the internal resistant of the MEA 10 that causes a voltage drop across the membrane 16 (E-IR free). Based on the oxygen polarization curve, the catalyst 2 provides a 20-30 mV enhancement over the catalyst 1.

The fuel cell performance for a pure oxygen oxidant gives the best kinetically controlled performance for both the catalysts 1 and 2. For low current densities using air as the cathode oxidant, the ORR is still kinetically controlled, so the catalyst 2 provides the best performance. This may be due to the high dispersivity of platinum on the smaller particles of carbon. However, for higher current densities using air, mass transport limitations occur as a result of flooding and the like. Flooding is the phenomenon that occurs when the pores in the catalyst layer are too small to allow water to be removed. The poor mass transport may be the result of smaller pores in the catalyst layer containing the catalyst 2.

### SUMMARY OF THE INVENTION

In accordance with the teachings of the present invention, an MEA for a PEMFC is disclosed that employs an improved electrode catalyst. The MEA includes an anode, a cathode and a polymer electrolyte membrane therebetween. The anode includes a gas diffusion layer and an anode catalyst layer proximate the electrolyte membrane. The cathode includes a gas diffusion layer and a cathode catalyst layer proximate the electrolyte membrane. In one embodiment, the catalyst for one or both of the anode catalyst layer and the cathode catalyst layer is a combination of a first supported catalyst and a second supported catalyst. The first supported catalyst may be about 50 wt % Pt and 50 wt % of a carbon particle such as Vulcan XC72 carbon having a BET surface area of about 250 m²/g. The second supported catalyst is a 50 wt % Pt and 50 wt % of a carbon particle such as Ketjen Black carbon having a BET surface area in the range of 600-1000 m²/g. In one embodiment, the BET surface area of the second catalyst is about 800 m²/g, and the ratio of the first supported catalyst to the second supported catalyst is 1:1.

Additional embodiments of the present invention will become apparent from the following description and appended claims, taken in conjunction with the accompanying drawings.

### BRIEF DESCRIPTION OF THE DRAWINGS

FIG. 1 is a cross-sectional plan view of an MEA for a PEMFC employing an improved catalyst, according to an embodiment of the present invention;

FIG. 2 is a graph with voltage on the vertical axis and current density on the horizontal axis showing polarization curves that give the fuel cell performance for oxygen and air for two different catalysts; and

FIG. 3 is the graph shown in FIG. 2, and including the fuel cell performance for the catalyst of the invention.

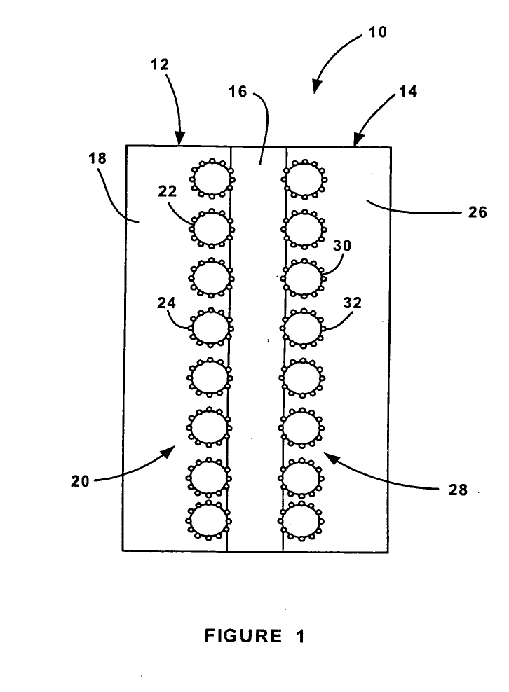

### DETAILED DESCRIPTION OF THE INVENTION

The following discussion of the embodiments of the invention directed to a catalyst for an MEA in a PEMFC is merely exemplary in nature, and is in no way intended to limit the invention or its applications or uses.

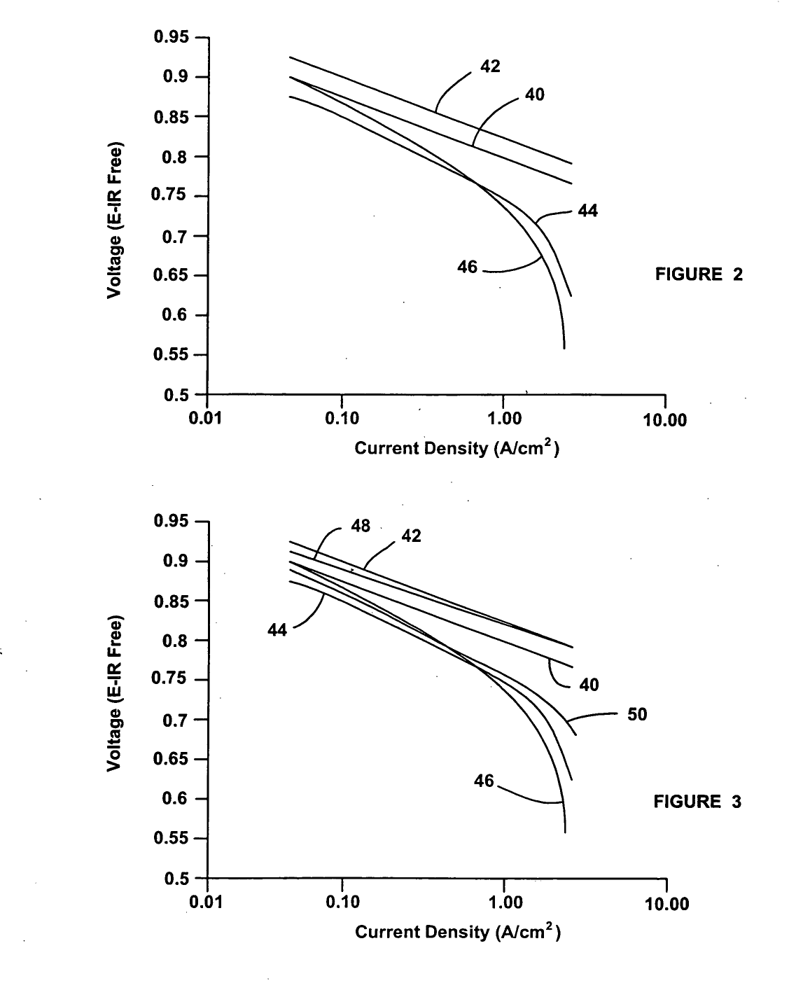

As discussed above, based on the polarization curves shown in FIG. 2, the catalyst 2 has a 20-30 mV increase over the catalyst 1 over the entire current density range in oxygen. In order to attain this advantage throughout the entire current density range in air, the present invention proposes mixing the supported catalysts 1 and 2 to provide an improved catalyst. In one embodiment, the two supported catalysts are mixed in a 1:1 ratio. The catalyst composition of the invention is an improvement over the supported catalysts 1 and 2 alone, because it provides an increased voltage output over the applicable range of current densities than either of the catalysts 1 and 2. Thus, the catalyst layers in an MEA can be made thinner, i.e., less Pt loading, to provide the same voltage output for higher Pt loaded catalysts. By combining the supported catalysts 1 and 2, the trade off between pore size and carbon surface area is improved. The catalyst layer is optimized by creating a balance between the higher surface area catalyst (catalyst 2) that has well dispersed Pt particles and the lower surface area (larger carbon particles) catalyst (catalyst 1), which has increased porosity.

FIG. 3 is the graph shown in FIG. 2 including the performance of the catalyst composition of the invention. For low current densities using air, fuel cell performance is slightly lower for the proposed catalyst of the invention, than for the catalyst 2 alone. However, at high current densities using air, cell performance follows the catalyst 1, but with a 30 mV enhancement throughout. The thickness at 0.4 mg/cm² loading for the catalyst of the invention is approximately 14 μm, which is similar to that of the catalyst 1. This suggests that the catalyst composition of the invention has a similar overall porosity to that of the supported catalyst 1, so that mass transport limitations follow the same trend. The advantages for the catalyst composition of the invention is that not only does it create a catalyst layer with a desirable porosity from the supported catalyst 1, but it also has a higher electro-catalytic activity due to the contribution from the high platinum dispersion from the catalyst 2.

According to the invention, the improved catalyst composition of the invention can be employed in the cathode catalyst layer 20 and/or the anode catalyst layer 28. It is believed that the greatest benefit can be attained by providing the catalyst in both of the catalysts layers 20 and 28.

One embodiment of the invention is a product including a catalyst composition including one or more catalyst on mixed supports including carbon. In one embodiment a catalyst composition is provided including a first supported catalyst including a first catalyst including at least one of Pt and Pt alloys, and first support particles including carbon. The first supported catalyst may include 10-70 wt % of the first catalyst and 30-90 wt % of the first support particles. The first catalyst is adhered to the first support particles. The first support particles may have a BET surface area in the range of 50-500 m²/g, and in another embodiment a BET surface area of about 250 m²/g. The catalyst composition also includes a second supported catalyst including a second supported catalyst including at least one of Pt and Pt alloys, and second support particles including carbon. The second supported catalyst may include 10-70 wt % of the second catalyst and 30-90 wt % of the second support particles. The second catalyst is adhered to the second support particles. The second support particles may have a BET surface area in the range of 600-2000 m²/g, and in another embodiment a BET surface area of about 600-1000 m²/g.

Variations of the supported catalysts 1 and 2 can be combined to provide the catalyst according of the invention. For example, other carbon supports besides Vulcan and Ketjen Black can be employed in both the anode 14 and the cathode 12, such as Acetylene Black having a BET surface area of 50-100 m²/g and Black Pearls having a BET surface area of the 1500-2000 m²/g. Further, mixtures of these various carbon supports, such as combinations of Acetylene Black, Ketjen Black, Vulcan, Black Pearls, etc., can be employed. According to the invention, it is desirable that the resulting catalyst be a combination of two or more catalysts having a low surface area carbon and a high surface area carbon.

Further, other weight percents of platinum can be employed in the catalysts 1 and 2. For example, the catalyst 1 can include 20 wt % Pt supported on Vulcan and the catalyst 2 can include 70 wt % Pt supported on Ketjen Black. The catalyst 1 can include 50 wt % Pt supported on Vulcan and the catalyst 2 can include 10 wt % Pt supported on Ketjen Black. The catalyst 1 can include 30 wt % Pt supported on Vulcan and the catalyst 2 can be 30 wt % Pt supported on Ketjen Black. Other suitable weight percents of platinum can also be employed. Also, the ratios of the catalysts 1 and 2 can be other than a 1:1 ratio. For example, the ratio of the catalyst 1 to the catalyst 2 can be 1:5 to 5:1, 1:2 to 2:1 or 1:0.8, etc.

Also, other catalyst metals can be employed, such as platinum alloys. For example, the catalyst metal can be PtRu, such as a combination of PtRu supported on Vulcan mixed with PtRu supported on Ketjen Black. The catalyst metal can be any suitable weight percent of a catalyst metal supported on carbon. The catalyst metal can be PtCo, PtFe, PtMi, PtSn, PtTi, PtRu or any other Pt alloy with any suitable transition metal or other non-noble metal catalysts.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A product comprising a catalyst composition comprising:
a first supported catalyst comprising a 10-70 wt % Pt or Pt alloy, the Pt or Pt alloy formed on first particles comprising carbon, the first particles having a BET surface area of about 250 m²/g; and
a second supported catalyst comprising a 10-70 wt % Pt or Pt alloy, the Pt or Pt alloy formed on second particles comprising carbon, the second particles having a BET surface area in the range of 600-1000 m²/g.

2. The product according to claim 1 wherein the catalyst composition is a 1:1 ratio of the first supported catalyst and the second supported catalyst.

3. The product according to claim 1 wherein the first supported catalyst comprises about a 50 wt % Pt or Pt alloy.

4. The product according to claim 1 wherein the second supported catalyst comprises about a 50 wt % Pt or Pt alloy.

5. The product according to claim 1 wherein the second particles have a surface area of about 800 m²/g.

6. The product according to claim 1 wherein the particles in the first and second supported catalysts comprise at least one of Acetylene Black, Black Pearls, Ketjen Black, Vulcan and combinations of Acetylene Black, Black Pearls, Ketjen Black and Vulcan.

7. The product according to claim 1 wherein the Pt alloy comprises at least one of PtRu, PtCo, PtFe, PtMi, PtSn, and PtTi.

8. The product according to claim 1 wherein the catalyst composition includes a catalyst loading less than 0.4 mg/cm².

9. The product according to claim 1 wherein the catalyst composition is part of one or both of an anode and a cathode in a membrane electrode assembly.

10. The product according to claim 9 wherein the membrane electrode assembly is part of a proton exchange membrane fuel cell.

11. A product comprising a mixture of a first supported catalyst and a second supported catalyst, said first supported catalyst comprising about a 50 wt % Pt, the Pt formed on Vulcan XC72 carbon particles having a BET surface area of about 250 m²/g, and said second supported catalyst comprising about a 50 wt % Pt, the Pt formed on Ketjen Black carbon particles having a BET surface area of about 800 m²/g.

12. The product according to claim 11 wherein the mixture is a 1:1 mixture of the first supported catalyst and the second supported catalyst.

13. The product according to claim 11 wherein the second particles have a catalyst loading less than 0.4 mg/cm².

14. The product according to claim 11 wherein the catalyst composition is part of one or both of an anode and a cathode in a membrane electrode assembly.

15. The product according to claim 14 wherein the membrane electrode assembly is part of a proton exchange membrane fuel cell.

16. A product comprising:
a membrane electrode assembly (MEA) for a proton exchange membrane fuel cell, said assembly comprising:
an electrolyte membrane;
an anode positioned on one side of the membrane; and
a cathode positioned on an opposite side of the membrane from the anode, said cathode comprising a cathode catalyst layer, said cathode catalyst layer comprising a catalyst composition made of a mixture of a first supported catalyst and a second supported catalyst, said first supported catalyst comprising a 10-70 wt % Pt or a Pt alloy, the Pt or Pt alloy formed on first particles comprising carbon, the particles having a BET surface area of about 250 m²/g, and said second supported catalyst comprising a 10-70 wt % Pt or a Pt alloy, the Pt or Pt alloy formed on second particles comprising carbon, the second particles having a BET surface area in the range of 600-120 m²/g.

17. The product according to claim 16 wherein the catalyst composition is a 1:1 ratio of the first catalyst and the second catalyst.

18. The product according to claim 16 wherein the first supported catalyst has about a 50 wt % Pt or Pt alloy.

19. The product according to claim 16 wherein the second supported catalyst includes about a 50 wt % Pt or Pt alloy.

20. The product according to claim 16 wherein the second particles have a BET surface area of about 800 m²/g.

21. The product according to claim 16 wherein the particles in the first and second supported catalysts comprise at least one of Acetylene Black, Black Pearls, Ketjen Black, Vulcan and combinations of Acetylene Black, Black Pearls, Ketjen Black and Vulcan.

22. The product according to claim 16 wherein the Pt alloy comprises at least one of PtRu, PtCo, PtFe, PtMi, PtSn, and PtTi.

23. The product according to claim 16 having a catalyst loading less than 0.4 mg/cm².

24. A method of making a catalyst composition, comprising:
providing a first supported catalyst including a 10-70 wt % Pt or a Pt alloy, the Pt or Pt alloy formed on first particles comprising carbon, the first particles having a BET surface area of about 250 m²/g;
providing a second supported catalyst including a 10-70 wt % Pt or a Pt alloy, the Pt or Pt alloy formed on second particles comprising carbon, the second particles having a BET surface area in the range of 600-1200 m²/g; and
mixing the first supported catalyst and the second supported catalyst to form the composition.

25. The method according to claim 24 wherein mixing the first supported catalyst and the second supported catalyst includes mixing the first supported catalyst and the second supported catalyst in a 1:1 ratio.

26. The method according to claim 24 wherein providing the first supported catalyst comprises providing the first supported catalyst comprising about a 50 wt % Pt or Pt alloy, the Pt or Pt alloy formed on Vulcan XC72 particles.

27. The method according to claim 24 wherein providing the second supported catalyst comprises providing the second supported catalyst comprising about a 50 wt % Pt or Pt alloy, the Pt or Pt alloy formed on Ketjen Black particles having a BET surface area of about 800 m²/g.

28. A product comprising:
a catalyst composition comprising a first supported catalyst comprising a first catalyst comprising at least one of Pt and Pt alloys, and first support particles including carbon, and wherein the first supported catalyst comprises 10-70 wt % of the first catalyst and 30-90 wt % of first support particles, and wherein the first catalyst is adhered to the first support particles, the first support particles having a BET surface area in the range of 50-500 m²/g; and
the catalyst composition further comprising a second supported catalyst comprising a second catalyst comprising at least one of Pt and Pt alloys, and second support particles comprising carbon, and wherein the second supported catalyst comprises 10-70 wt % of the second catalyst and 30-90 wt % of the second support particles, and wherein the second catalyst is adhered to the second support particles, and the second support particles having a BET surface area in the range of 600-2000 m²/g.

29. A product as set forth in claim 28 wherein the first support particles have a BET surface area of about 250 m²/g.

30. A product as set forth in claim 28 wherein the second support particles have a BET surface area of about 600-1000 m²/g.
